(19) United States
(12) Patent Application Publication
(10) Pub. No.: US 2012/0151714 A1
(43) Pub. Date: Jun. 21, 2012

(54) Hold-open device for holding a roll-up door in an overhead out-of-the-way position

(75) Inventor: Mark J Szczygielski, Akron, NY (US)

(73) Assignee: Whiting Door Manufacturing Corporation

(21) Appl. No.: 12/928,748

(22) Filed: Dec. 17, 2010

(51) Int. Cl. E05F 5/00

(52) U.S. Cl. 16/82

(57) ABSTRACT

The present invention provides an improved hold-open device (50) for holding a roll-up door (55, 56) in an overhead out-of-the-way position in a body, the door being mounted for movement within a track (51) having a vertical portion (52), an arcuate portion (53) and a horizontal portion (54). The improved device broadly includes: a plate (62) mounted on one of the track and cargo body; an arm (63) pivotally mounted on the plate; a striker (64) mounted on the door, the striker having an inclined surface (79) and an abutment surface (80); a stop (70) mounted on the arm, the stop having an edge (87) adapted to selectively engage the striker surfaces; and at least one spring (25) urging the arm to move such that the edge will engage one of the striker surfaces.

### TECHNICAL FIELD

The present invention relates generally to roll-up doors, and, more particularly, to improved hold-open devices that are adapted to selectively hold a roll-up door in an overhead out-of-the-way position so as to maximize the projected cross-sectional area of the access opening in which the door is mounted.

### BACKGROUND ART

Roll-up doors are widely known, and are commonly used to selectively close access openings in various bodies. Some bodies are stationary, and the roll-up door is used, for example, to selectively control access to a garage or warehouse. Other bodies are mounted on vehicles, such as on cargo-carrying trucks and trailers.

In either case, it is sometimes desired to hold the roll-up door in a particular position such that the projected cross-sectional area of the body access opening will be maximized so as to facilitate the ingress or egress of goods. This position may be other than the normal lifted overhead position of the door.

To this end, various types of hold-open devices for roll-up doors have been developed.

In one form of a prior art hold-open device, a clevis member was welded to the bottom of an arcuate portion of the track between the lower vertically-disposed portion and the overhead horizontally-disposed portion. An intermediately-pivoted dogleg-shaped clevis arm was mounted on the clevis member, and was weight-biased such that a striker on one end of the arm would move toward a catch mounted on the door. When the door was moved overhead, the catch had a forwardly- and downwardly-facing inclined surface, and a rearwardly-facing abutment surface. A release cable or lanyard was attached to the underweighted arm portion adjacent the striker. The door could be moved upwardly to an overhead out-of-the-way position. As it moved toward this position, an edge on the arm-mounted striker would ride up the inclined surface on the catch. At the end of this motion, the weighted arm would pivot, and the striker edge would face and engage the abutment surface to hold the door in the overhead out-of-the-way position. However, it was found that sometimes the striker edge would only marginally engage the catch abutment surface so that the door might be insecurely held in the overhead position, particularly if the movement of the weighted arm was slowed, as by dirt in the pivotal connection between the arm and the clevis member.

In another form of a prior art hold-open device, a latch mounted on the upper edge of the uppermost panel of the door was arranged to engage a keeper. In other words, a version of the latch-keeper mechanism on the lowermost door panel was again provided on the uppermost door panel to selectively hold the door in the overhead out-of-the-way position. While effective to hold the door, this arrangement added unnecessary cost and weight to the door. Moreover, it is difficult to properly and effectively brace a latch bar in the center of an eight-foot span of cargo body that is essentially frameless. A “slam” lock can displace or distort the catch bar to the point of being inoperative. Also, this design places an obstacle right in the middle of the freight area, and is of concern because of the possibility of being hit by freight or a fork lift.

Accordingly, it would be desirable to provide an improved hold-open device for a roll-up door that could selectively hold a door in an overhead out-of-the-way position.

### DISCLOSURE OF THE INVENTION

With parenthetical reference to the corresponding parts, portions or surfaces of the disclosed embodiment, merely for purposes of illustration and not by way of limitation, the present invention provides an improved hold-open device (50) for holding a roll-up door (55, 56) in an overhead out-of-the-way position in a body, the door being mounted for movement within a track (51) having a vertical portion (52), an arcuate portion (53) and an horizontal portion (54).

The improved device broadly includes: a plate (62) mounted on one of the track and cargo body; an arm (68) pivotally mounted on the plate; a striker (64) mounted on the door, the striker having an inclined surface (79) and an abutment surface (80); a stop (70) mounted on the arm, the stop having an edge adapted to engage the striker surfaces; and at least one spring (65) urging the arm to move such that the edge will engage one of the striker surfaces.

The device may further include a first stop (71′) mounted on the plate for limiting pivotal movement of the arm in one angular direction.

The device may further include a second stop (71″) mounted on the plate for limiting pivotal movement of the arm in the opposite angular direction.

The first and second stops may be mounted on an arm stop (71) secured to the plate.

A marginal end portion of the plate may engage a portion of the track in area contact, and may be welded to the track portion. The track portion may be on the horizontal portion.

A distal end portion (68) of the arm may be arranged adjacent the opening of the cargo body that is closed by the roll-up door.

The spring may act between said plate and door.

In a presently-preferred embodiment, two springs (65, 65) urge said arm to move relative to said plate.

The inclined surface may face forwardly and downwardly, and the abutment surface may face rearwardly toward the access opening in which the roll-up door is mounted, when the door is in the overhead position.

The improved device may be mounted in a static structure, such as garage or warehouse, or may be mounted in a vehicle-mounted cargo body, such as in a truck or trailer.

Accordingly, the general object of the invention is to provide an improved hold-open device for selectively holding a roll-up door in an overhead out-of-the-way position.

Another object is to provide an improved hold-open device that is relatively simple and uncomplicated in structure and construction, and that is reliable in operation.

These and other objects and advantages will become apparent from the foregoing and ongoing written specification, the drawings and the appended claims.

### BRIEF DESCRIPTION OF THE DRAWINGS

FIG. 1 is a fragmentary vertical sectional view of a prior art hold-open device having a clevis member mounted on the underside of the track, and a dogleg-shaped weighted clevis arm mounted on the clevis member and adapted to selectively engage a catch mounted on the lowermost door panel.

FIG. 2 is a fragmentary left end elevation of the track shown in FIG. 1, with the door removed.

FIG. 3 is a plan view of the door-mounted catch.

FIG. 4 is a right end elevation of the catch shown in FIG. 3.

FIG. 5 is a fragmentary transverse detail view showing how the prior art clevis member was attached to the track, and further showing the dogleg-shaped arm mounted thereon.

FIG. 6 is a side elevation of the clevis member and the arm shown in FIG. 5.

FIG. 7 is a fragmentary vertical sectional view of an improved hold-open device mounted on a track, and engaging a catch mounted on the second roll-up door panel.

FIG. 8 is a fragmentary left end elevation of the structure shown in FIG. 7, with the latch mechanism removed for clarity.

FIG. 9 is a fragmentary front elevation of the improved hold-open device detached from the track.

FIG. 10 is a left end elevation of the structure shown in FIG. 9.

FIG. 11 is a top plan view of the shoulder rivet.

FIG. 12 is a front elevation of the structure shown in FIG. 11.

FIG. 13 is a front elevation of the plate shown in FIG. 9.

FIG. 14 is a left end elevation of the plate shown in FIG. 13.

FIG. 15 is a front elevation of the catch shown in FIG. 7.

FIG. 16 is a left end elevation of the catch shown in FIG. 15.

FIG. 17 is a top plan view of the catch shown in FIG. 16.

FIG. 18 is a front elevation of the arm shown in FIG. 9

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

### Prior Art Hold-Open Device (FIGS. 1-6)

Referring now to the drawings, a prior art hold-open device is shown in FIG. 1 in association with the curved section of a track. This hold-open device, generally indicated at 20, included a clevis member 21 and a weighted dogleg-shaped arm 22.

In FIG. 1, the lowermost door panel is indicated at 23, and is shown as being operatively mounted on track 24 via rollers 25, 26. As previously noted, this is the lowermost panel section. There would normally be other panel sections to the left of this, but these have been omitted in the interest of clarity. A latch mechanism, generally indicated at 28, is shown in outline form as being mounted on door panel 23. This latch mechanism may, for example, be of the general type disclosed in U.S. Pat. No. 3,740,978, and is used to hold the lowered door to the sill. However, the latch mechanism forms no part of the present invention.

As best shown in FIGS. 2 and 5, the clevis member 21 is actually a reversely-folded member having an arcuate upper end, and two parallel legs terminating in lower distal ends. The arcuate upper end was welded, as indicated by weldment 29, to the underside of the curved portion of the track 24.

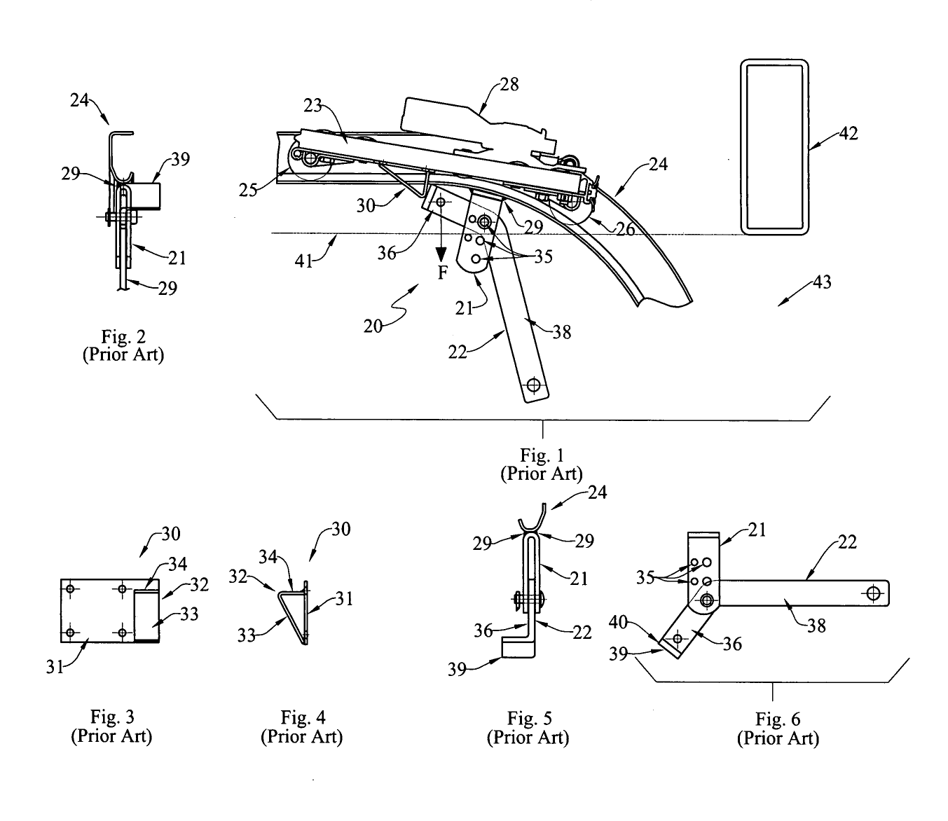

A striker, generally indicated at 30, was suitably secured to the inside of the lowermost door panel 23. As best shown in FIGS. 3 and 4, this striker had a rectangular plate-like portion 31 and another portion 32 secured thereto. This other portion 32 had an inclined surface 33 and an abutment surface 34.

As best shown in FIGS. 1 and 6, the clevis member had a plurality of through-holes, severally indicated at 35. The arm was adapted to be mounted in the appropriate one of these through-holes, as determined by the size, shape and configuration of the lowermost panel. The arm 22 is shown as being intermediately-pivoted member having a smaller mass portion 36 and a larger mass portion 38. A stop 39 extends outwardly from the smaller mass portion 36. This stop has an edge 40 that is adapted to selectively engage the striker.

When the door is moved to an overhead out-of-the-way position, the edge 40 of the arm would engage the striker inclined portion 33, and would cause the arm to pivot the arm as the door was raised. Finally, the edge would come to the apex between the striker inclined surface and abutment surface, and would then move past. Thereafter, the larger mass of arm portion 38 would cause the arm to pivot in a clockwise direction (as seen in FIG. 1), such that the end of the arm stop 39 would engage the striker abutment surface. This would then hold the door in a raised overhead out-of-the-way position. FIG. 1 illustrates that the entire door is physically arranged above a projected horizontal line 41 issuing from body header 42. Thus, this maximized the projected cross-sectional area of the opening 43 that was normally closed or secured by the door.

To release the mechanism, the door was pushed further upwardly, and a force F was applied to the smaller mass portion to cause arm 22 to pivot in a counterclockwise direction such that the striker could then pass by the stop and door could be lowered. This force could be applied by pulling a release cable or lanyard (not shown) downwardly.

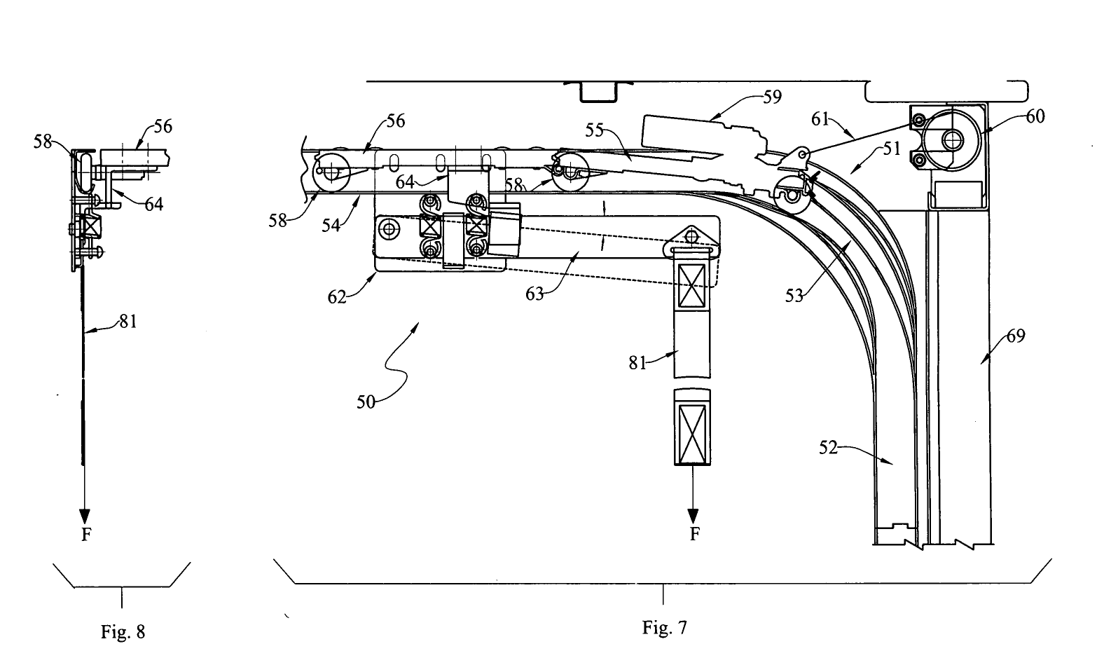

### Improved Hold-Open Device (FIGS. 7-18)

Referring now to FIGS. 7 and 8, an improved hold-open mechanism is generally indicated at 50, and is utilized to hold a roll-up door in an overhead out-of-the-way position. In FIG. 7, the track 51 is shown as including a vertical portion 52 an arcuate portion 53, and an overhead horizontal portion 54.

In FIG. 7, the door is shown as having a lowermost panel 55 and an immediately adjacent panel 56 to the left thereof. These panels are supported by rollers, severally indicated at 58. A latch mechanism is again indicated in outline form at 59. A torsional spring 60 is connected to the lowermost door panel 55 by a cable 61. This spring facilitates the raising and lowering of the door, by counter-balancing some of its weight.

Hold-open device 50 is shown as broadly including a plate member 62, an arm 63, a striker 64 mounted on one of the door panels, and a pair of springs, severally indicated at 65.

Plate 62 is shown as being a rectangular plate-like member having a plurality of horizontally-spaced vertically-elongated oval-shaped openings, severally indicated at 66. This upper marginal end portion of the plate is adapted to be welded, or otherwise secured, in area contact to the flat vertical side of the track. Thus, the one salient difference between the present arrangement and the prior art arrangement is that the hold-open plate is secured in area contact to the track, whereas in the prior art arrangement, the clevis member was welded to the arcuate bottom of the track. Hence, in the improved device, the area of contact and weldments are greater than in the prior art.

Arm 63 is shown as being a horizontally-elongated rectangular member, one marginal end portion of which is pivotally mounted on the plate. The pivotal connection is indicated at 57. The distal end portion 68 of the arm extends rearwardly toward the cargo access opening 69 (FIG. 7). In this form, two springs 65, 65 act between pins, severally indicated at 67, mounted on the plate and arm, and urge the arm to move in a counterclockwise direction about pivot point 57.

The arm carries a stop 70 at an intermediate portion of its longitudinal extent. This stop is arranged to selectively engage a striker 64 mounted on the door (FIG. 7). In this case, the striker is mounted on the second door panel; i.e., the door panel that is adjacent the lowermost door panel. A U-shaped stop, generally indicated at 71, is welded to the plate, and surrounds an intermediate portion of the arm. The horizontal portions (71′, 71″) of this stop provide limit stops for movement of the arm in either angular direction.

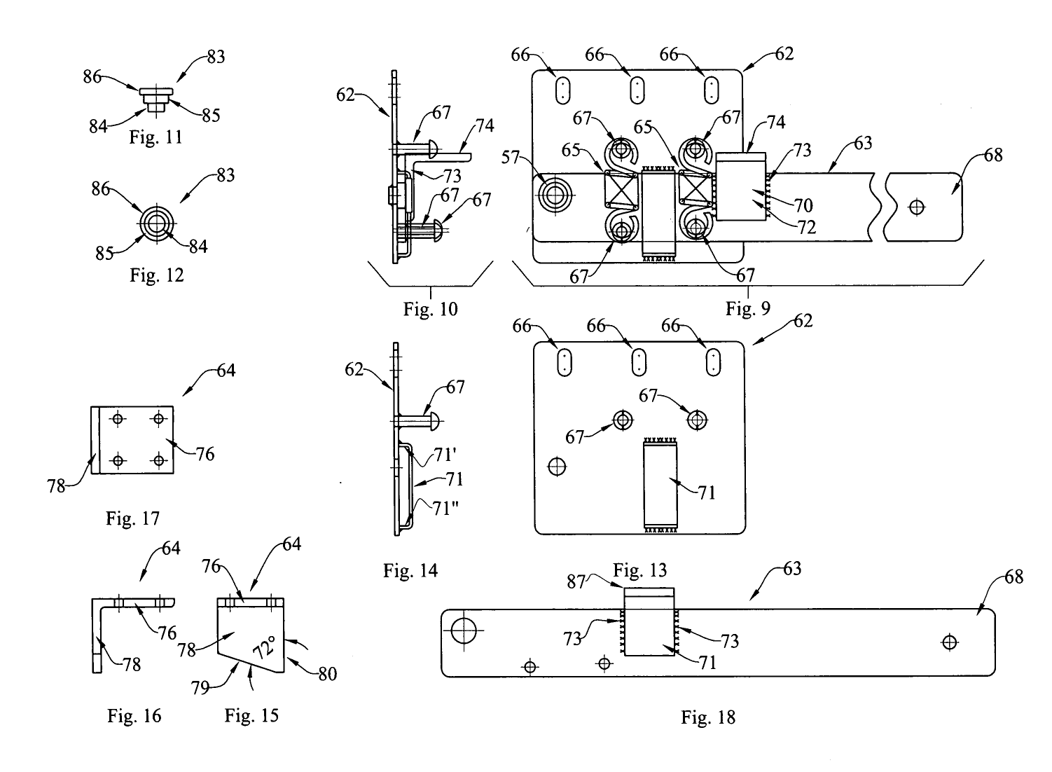

As best shown in FIGS. 9 and 10, the arm stop 70 is shown as being an L-shaped member having one portion 72 engaging the arm and being welded thereto, as indicated by weldment 73. Another portion 74 extends transversely outwardly from the upper margin of portion 72, and is adapted to engage the striker.

Referring now to FIGS. 15-17, the striker 64 is shown is being an L-shaped member having a plate-like portion 76, and another portion 78 extending perpendicularly outwardly therefrom. Portion 78 is shown as having an inclined surface 79, and an abutment surface 80. When the striker is mounted on the door panel, the inclined surface 79 faces forwardly and downwardly, and the abutment surface 80 faces rearwardly, as shown in FIG. 7. Thus, when the door is moved along the track to an overhead out-of-the-way position, the edge 87 of stop 70 will engage the inclined surface 79 of the striker and cause the arm to pivot in a clockwise direction until such time as the stop passes by the inclined portion. Thereafter, the springs will expand to cause the arm to move upwardly in a counterclockwise direction such that the arm stop will face or engage the striker abutment surface 80.

Referring now to FIGS. 11 and 12, a shoulder rivet 83 is operatively positioned between the arm and plate. This rivet is shown as having a stepped outer surface that includes a small-diameter portion 83, and intermediate-diameter portion 84, and a large-diameter portion 86. The principal function of rivet 83 is to hold the arm away from the plate so as to reduce frictional contact therebetween.

To release the mechanism, an operator need only grasp the release cable or lanyard 81, and pull it downwardly, to cause the arm to rotate in a clockwise direction about pivot point 57. Once the stop is beneath the striker, the door may be moved downwardly to its access-closing position. It should be noted that in the improved embodiment, the release lanyard is physically located adjacent the rear access opening, so as to facilitate grasping by an operator reaching from outside the door to release the hold-open device. Moreover, the device may be released by pulling the release cord vertically downwardly. This is a significant advantage over prior art devices that required an angled pull.

Moreover, the improved design with positive spring force overcomes interference caused by direct and debris interfering with the pivotal movement of the arm, and gives the mechanism a “quickness” to rapidly snap into the hold-open “engaged” position. As the door is moved upwardly, the arm-mounted stop edge rides up the striker inclined surface. This further displaces the springs and increases the force that urges the arm-mounted stop edge to snap into engagement with the striker abutment surface once the door has been moved past the striker.

### Modifications

The present invention contemplates that many changed and modifications may be made. For example, materials of construction are not deemed to be particular critical, and may be changed or varied, as desired. In the improved embodiment, one or more springs may be used. These may be coil springs, as shown, or may be some other type of spring. The particular form of the arm stop is exemplary, and may be changed or modified as desired. While the disclosed embodiment of the hold-open device is described as having been mounted on the track, in a stationary application, such as in a garage or warehouse, the hold-open device could be mounted to some other portion of the static structure. In a vehicular application, the portion of the hold-open device could possibly be mounted on the cargo body, rather than the track. The striker and stop are not limited to these particular forms as shown, but may assume other shapes and configurations as well.

Therefore, while a presently preferred form of the improved hold-open device has been shown and described, and several modifications thereof discussed, persons skilled in this art will readily appreciate the various additional changes and modifications may be made without departing from the spirit of the invention, as defined and differentiated by the following claims.

What is claimed is:

1. A hold-open device for holding a roll-up door in an overhead out-of-the-way position in a body, said door being mounted for movement within a track having a vertical portion, an arcuate portion and an horizontal portion, comprising:
a plate mounted on one of said track and cargo body;
an arm pivotally mounted on said plate;
a striker mounted on said door, said striker having an inclined surface and an abutment surface;
a stop mounted on said arm, said stop having an edge adapted to engage said striker surfaces; and
at least one spring urging said arm to move such that said edge will engage one of said striker surfaces.

2. A hold-open device as set forth in claim 1 and further comprising a first stop mounted on said plate for limiting pivotal movement of said arm in one angular direction.

3. A hold-open device as set forth in claim 2 and further comprising a second stop mounted on said plate for limiting pivotal movement of said arm in the opposite angular direction.

4. A hold-open device as set forth in claim 3 wherein said first and second stops are mounted on an arm stop secured to said plate.

5. A hold-open device as set forth in claim 1 wherein a portion of said plate engages a portion of said track in area contact.

6. A hold-open device as set forth in claim 5 wherein said plate portion is welded to said track portion.

7. A hold-open device as set forth in claim 6 wherein said track portion is on said horizontal portion.

8. A hold-open device as set forth in claim 1 wherein a distal end portion of said arm is arranged adjacent the opening of said cargo body that is closed by said roll-up door.

9. A hold-open device as set forth in claim 1 wherein said spring acts between said plate and door.

10. A hold-open device as set forth in claim 9 wherein two springs urge said arm to move relative to said plate.

11. A hold-open device as set forth in claim 1 wherein said inclined surface faces forwardly and downwardly.

12. A hold-open device as set forth in claim 1 wherein said abutment surface faces rearwardly.

13. A hold-open device as set forth in claim 1 wherein said body is a vehicle-mounted cargo body.
